(19) United States
(12) Patent Application Publication
(10) Pub. No.: US 2010/0045548 A1
(43) Pub. Date: Feb. 25, 2010

(54) Motor-vehicle antenna for satellite data communication

(75) Inventors: Ingmar Petersen, Esslingen (DE); Bernd Schwarz, Waldorfhaslach (DE); Markus Pfletschinger, Eningen (DE); Ying Zhang, Leinfelden-Echterdingen (DE)

Correspondence Address: K.F. ROSS P.C., 5683 RIVERDALE AVENUE, SUITE 203 BOX 900, BRONX, NY, 10471-0900, US

(73) Assignee: Hirschmann Car Communication GmbH

(21) Appl. No.: 12/012,008

(22) Filed: Jan. 30, 2008

(30) Foreign Application Priority Data
Feb. 2, 2007 (DE) 102007005265.2

(51) Int. Cl. H01Q 1/32

(52) U.S. Cl. 343/713

(57) ABSTRACT

In combination with a motor-vehicle body part, an antenna has a flat nonconductive support sheet, a conductive antenna structure applied to the sheet, and a coaxial cable connected to the antenna structure and adapted for connection to a transmitter or receiver.

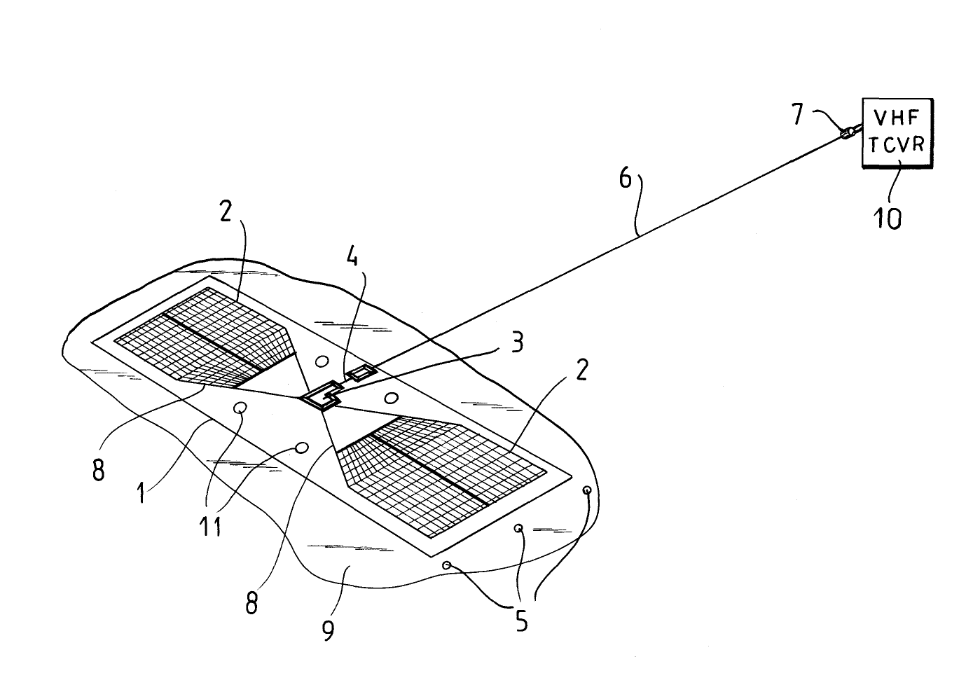

### FIELD OF THE INVENTION

The present invention relates to an antenna. More particularly this invention concerns an antenna that is mounted on a motor vehicle for high-frequency data communication with a satellite.

### BACKGROUND OF THE INVENTION

It is known to fix an antenna to a motor vehicle and to connect it via a cable, typically a coaxial cable, to a receiver and/or transmitter in the vehicle. More particularly such an antenna is typically used for radio and telephone communication. They are not suited for exceedingly high frequency reception via satellite.

### OBJECTS OF THE INVENTION

It is therefore an object of the present invention to provide an improved motor-vehicle antenna for satellite data communication.

Another object is the provision of such an improved motor-vehicle antenna for satellite data communication that overcomes the above-given disadvantages, in particular that can be used for very high-frequency communication.

### SUMMARY OF THE INVENTION

In combination with a motor-vehicle body part, an antenna has according to the invention a flat nonconductive support sheet, a conductive antenna structure applied to the sheet, and a coaxial cable connected to the antenna structure and adapted for connection to a transmitter or receiver.

Thus according to the invention, the antenna is of a flat, rigid or flexible construction, with a nonconductive support, on which the antenna structure is mounted. In this manner, it is possible to attach this antenna in the desired location of the car and also to insert it between a roof liner and a roof made of a plastic or synthetic material of a car. Furthermore, the antenna is flat and space-saving, so that no projecting bars, bumps, etc. are present. The fact that the support can be constructed as a flexible foil makes a highly accurate adjustment of the antenna to the actual shape of the car possible.

The antenna structure advantageously is a conductive material applied by means of a printing process, in particular a screen-printing technique, to the support. Using such printing process is particularly advantageous, in particular if the antenna is constructed in a larger number of pieces. The antenna structure extends a base point to which the cable is connected.

However, coming from the base point, a circuit or conductor can also be arranged, to which the cable or a connector or plug, in particular a high-frequency connector, is connected. The circuit may likewise also be constructed of a conductive material and applied at least partially to the foil. By means of the circuit, it is possible to connect the cable or the high frequency connector to an advantageous location, in particular, in the edge area or outside the foil, so that no major thickening of the actual foil area is present.

A protective coating layer may be applied to the antenna structure, particularly to the base point, the circuit section and the connection area that protects the antenna against outside influences. The protective layer, which advantageously consists of plastic, can be sprayed on, a plastic being used that is ductile when warm state and hard when cold. A so-called “hot-melt plastic” may be used.

The antenna and the support can be easily fastened to a component of the car via openings or holes, i.e. clipped in. Of course, other fastening methods, i.e. via an edge clip, are possible.

The antenna and the antenna structure may be symmetrically constructed, preferably symmetrical to the base point and thus function as a dipole.

### BRIEF DESCRIPTION OF THE DRAWING

The above and other objects, features, and advantages will become more readily apparent from the following description, reference being made to the accompanying drawing whose sole FIGURE is a partly schematic view from above of the instant invention.

### SPECIFIC DESCRIPTION

As seen in the drawing an antenna 2 is provided on a flexible support foil 1 that is laminated to an outer surface of a part, here a roof 9, of a motor vehicle in which is provided a VHF transmitter/receiver 10. The antenna 2 is formed by flexible conductive traces printed on the foil by screen printing. The antenna 2 in turn is connected via a conductor 4 applied to the foil to a base 3 connected to a core of a coaxial cable 6 having at its other end a connector 7 secured to the transceiver 10.

The support 1 and antenna 2 are symmetrical with the base point at the symmetry line, making the antenna 2 a dipole. The base part 3 incorporates a circuit that, like the antenna 2 is coated with a hot-melt plastic that is sprayed on and not visible here, forming an upper layer on the foil 1. The sprayed-on layer increases the stiffness of the foil, thereby facilitating connection to the cable 6.

The support 1 is formed with holes 11 so that it can be fitted accurately in the vehicle, for instance between the roof liner and a roof made of plastic or other rf-transparent material.

Thus according to the invention the antenna can be ideally suited for uplink in the 148 MHz to 150.05 MHz range and for downlink in the 137 MHz to 138 MHz range.

We claim:

1. In combination with a motor-vehicle body part, an antenna comprising:
a flat nonconductive support sheet;
a conductive antenna structure applied to the sheet; and
a coaxial cable connected to the antenna structure and adapted for connection to a transmitter or receiver.

2. The combination defined in claim 1 wherein the support sheet is a flexible foil.

3. The combination defined in claim 2 wherein the antenna structure is printed on the foil.

4. The combination defined in claim 3 wherein the antenna structure includes a base point to which the coaxial cable is connected.

5. The combination defined in claim 4, further comprising
a conductor applied to the support sheet and extending between the base point and the coaxial cable.

6. The combination defined in claim 3, further comprising
a nonconductive protective layer overlying the structure on the foil.

7. The combination defined in claim 6 wherein the layer is a sprayed-on plastic.

8. The combination defined in claim 7 wherein the plastic is flexible when warm.

9. The combination defined in claim 3 wherein the support foil is formed with holes for attachment to the body part.

10. The combination defined in claim 3 wherein the antenna structure is symmetric and a dipole, and the coaxial cable is connected to the antenna structure generally at a symmetry line.
